(19) United States
(12) Patent Application Publication
(10) Pub. No.: US 2021/0039019 A1
(43) Pub. Date: Feb. 11, 2021

(54) BAFFLE DESIGN FOR A DE-AERATION TANK

(71) Applicant: CUMMINS INC., Columbus, IN (US)

(72) Inventors: Randal L. Bergstedt, Columbus, IN (US); Rohit Saha, Columbus, IN (US); Eric P. Greene, Franklin, IN (US)

(73) Assignee: CUMMINS INC., Columbus, IN (US)

(21) Appl. No.: 16/984,561

(22) Filed: Aug. 4, 2020

Related U.S. Application Data
(60) Provisional application No. 62/883,217, filed on Aug. 6, 2019.

(51) Int. Cl. B01D 19/00

(52) U.S. Cl. CPC B01D 19/0042

(57) ABSTRACT

A de-aeration tank comprises a housing defining an interior volume. A first baffle comprises a first baffle first portion coupled to a first baffle second portion. The first baffle first portion extends away from the first baffle second portion at a nonzero angle, and the first baffle second portion is positioned so as to come into contact with the fluid entering the housing through an inlet vent. A first air vent is defined by a first distance between the first portion and the housing. A second baffle comprises a second baffle first portion coupled to the second baffle second portion. The second baffle first portion extends away from the second baffle second portion at a nonzero angle, and the second baffle second portion is positioned so as to come into contact with the fluid directed by the second portion and direct the fluid toward the bottom of the interior volume.

### CROSS-REFERENCE TO RELATED PATENT APPLICATIONS

This application claims priority to and the benefit of U.S. Provisional Application No. 62/883,217, filed Aug. 6, 2019, incorporated herein by reference in its entirety.

### TECHNICAL FIELD

The present invention relates generally to systems for removing air from liquids in a cooling system of a vehicle.

### BACKGROUND

De-aeration tanks are used to remove air from liquids present in an engine, a radiator, plumbing, and other accessories present in a vehicle. As used herein, the term “vehicle” refers to any device or system that requires an engine for propulsion. Examples of a vehicle include, but are not limited to, cars, trucks, boats, and airplanes. The cooling system of a vehicle typically includes a mixture of coolant and water (collectively referred to herein as “coolant”). In some instances, the coolant also includes air trapped within the coolant. When the coolant is in a storage container, the air is able to escape from the mixture as air travels to the surface of the coolant in the container. Accordingly, the coolant can be contained in a de-aeration tank when it is not circulating through the vehicle systems. However, conventional de-aeration tanks may not provide sufficient pathways for air to escape to effectively de-aerate the coolant.

### SUMMARY

In one set of embodiments, a de-aeration tank for removing air from a fluid comprises a housing defining an interior volume. A first baffle is coupled to the housing, the first baffle comprising a first baffle first portion coupled to a second portion. The first baffle first portion extends away from the first baffle second portion at a nonzero angle, and the first baffle second portion is positioned so as to come into contact with the fluid entering the housing through an inlet vent and direct the fluid to a second baffle second portion. A first air vent is defined by a first distance between the first baffle first portion and the housing. A second baffle is coupled to the housing, the second baffle comprising a second baffle first portion coupled to the second baffle second portion. The second baffle first portion extends away from the second baffle second portion at a nonzero angle, and the second baffle second portion is positioned so as to come into contact with the fluid directed by the second portion and direct the fluid toward the bottom of the interior volume. A second air vent is defined by a second distance between the second baffle first portion and the housing.

In another set of embodiments, a fluid circuit for circulating fluid through an engine system is provided. A de-aeration tank comprises a housing defining an interior volume. A first baffle is coupled to the housing, the first baffle comprising a first baffle first portion coupled to a first baffle second portion, the first baffle first portion extending away from the first baffle second portion at a nonzero angle. A first air vent is defined by a first distance between the first baffle first portion and the housing. A second baffle is coupled to the housing, the second baffle comprising a second baffle first portion coupled to a second baffle second portion, the second baffle first portion extending away from the second baffle second portion at a nonzero angle. A second air vent is defined by a second distance between the second baffle first portion and the housing. An inlet vent is coupled to the housing and positioned above a fill line of the fluid, the inlet vent configured to direct fluid to the first baffle. A pump inlet is coupled to the housing and is positioned at a bottom of the housing, the pump inlet configured to direct fluid to a fluid pump.

In yet another set of embodiments, a baffle system for a de-aeration tank includes a first baffle configured to couple to a housing. The first baffle includes a first baffle first portion coupled to a first baffle second portion, the first baffle first portion extending away from the first baffle second portion at a nonzero angle. A second baffle is configured to couple to the housing and includes a second baffle first portion positioned opposite the first baffle first portion, the second baffle first portion coupled to a second baffle second portion, the second baffle first portion extending away from the second baffle second portion at a nonzero angle. When the first baffle and the second baffle are coupled to the housing, an end of the first baffle second portion is positioned a first distance above the second baffle second portion.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is an illustration of a cross-section of a de-aeration tank, according to a particular embodiment.

### DETAILED DESCRIPTION

Following below are more detailed descriptions of various concepts related to, and implementations of, methods, apparatuses, and systems for removing air from liquids in a cooling system of a vehicle. The various concepts introduced above and discussed in greater detail below may be implemented in any of numerous ways, as the described concepts are not limited to any particular manner of implementation. Examples of specific implementations and applications are provided primarily for illustrative purposes.

### I. Overview

Implementations herein relate to a system for de-aeration of liquid in a vehicle. In some implementations, a de-aeration tank is configured to hold coolant for the vehicle. The de-aeration tank includes a first baffle and a second baffle configured to direct coolant from one or more inlet vents to a pump inlet. The first baffle and the second baffle each include vertical portions spaced apart from the tank walls to provide pathways for air to escape from the coolant, and angular portions to provide pathways for the coolant to flow toward the bottom of the de-aeration tank. A vortex breaker is positioned adjacent to the pump inlet to prevent a vortex of coolant from forming as the coolant enters the pump inlet from the de-aeration tank.

### II. Example De-aeration Tank

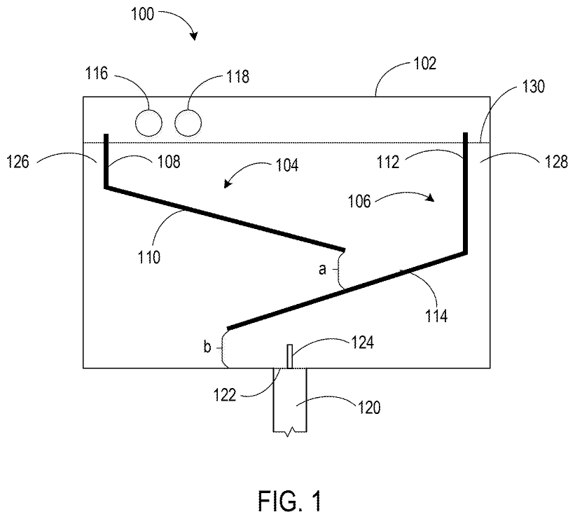

FIG. 1 is an illustration of a cross-section of a de-aeration tank 100, according to a particular embodiment. The de-aeration tank 100 is shown to include a housing 102, a first baffle 104, a second baffle 106, a first inlet vent 116, a second inlet vent 118, a pump inlet 120, an aperture 122, and a vortex breaker 124.

The housing 102 is sized and configured to contain the components included in the de-aeration tank 100. The housing 102 can be manufactured from any material suitable for that purpose including, but not limited to, metals, plastics, and composites. As shown, the housing 102 is square or rectangular in shape, however it should be understood that the shape of the housing 102 can be any shape suitable to perform the desired function.

The first baffle 104 is coupled to the housing 102 and is configured to receive coolant from the first inlet vent 116 and the second inlet vent 118 and direct the coolant toward the second baffle 106. The first baffle 104 can be coupled to the housing 102 by any connection suitable for the application. In some embodiments, the first baffle 104 can be coupled to the housing 102 via one or more connectors (not shown) attached to the bottom of the housing 102. The first baffle 104 can additionally or alternatively be coupled to the housing 102 via one or more connectors (not shown) attached to the side of the housing 102.

The first baffle 104 can be manufactured from any material suitable for its purpose including, but not limited to, plastics, metals, and composites. The first baffle 104 is further shown to include a first baffle first portion 108 and a first baffle second portion 110. The first baffle first portion 108 extends above a fill line 130 (e.g., the line to which the coolant fills the de-aeration tank 100) and is horizontally positioned between the first inlet vent 116 and the housing 102 such that coolant exiting the first inlet vent 116 is directed away from the housing 102 by the first baffle first portion 108. In some embodiments, the first baffle first portion 108 is oriented vertically (e.g., 90 degrees from horizontal). However, it is possible for the first baffle first portion 108 to have other angles relative to horizontal. For example, the first baffle first portion 108 can be angled approximately 45-89 degrees from horizontal. The first baffle first portion 108 is spaced apart from the housing 102 such that a first air vent 126 is defined. The first air vent 126 is configured to provide a conduit through which trapped air can travel to reach the fill line 130.

The first baffle second portion 110 is integrally formed with or otherwise coupled to the first baffle first portion 108 and extends from the bottom of the first baffle first portion 108 such that the first baffle second portion 110 is angled toward the bottom of the de-aeration tank 100. The first baffle first portion 108 and the first baffle second portion 110 are configured such that the angle between the first baffle first portion 108 and the first baffle second portion 110 is a nonzero angle. The first baffle second portion 110 is configured to direct fluid (e.g., coolant) toward the bottom of the de-aeration tank 100 by providing a surface on which fluid can flow.

The second baffle 106 is coupled to the housing 102 and is configured to receive coolant from the first baffle 104 and direct coolant to the bottom of the de-aeration tank 100. The second baffle 106 can be coupled to the housing 102 by any connection suitable for the application. In some embodiments, the second baffle 106 can be coupled to the housing 102 via one or more connectors (not shown) attached to the bottom of the housing 102. The second baffle 106 can also be coupled to the housing 102 via one or more connectors (not shown) attached to the side of the housing 102.

The second baffle 106 can be manufactured from any material suitable for its purpose including, but not limited to, plastics, metals, and composites. The second baffle 106 is further shown to include a second baffle first portion 112 and a second baffle second portion 114. The second baffle first portion 112 extends above the fill line 130 and is horizontally positioned such that the second baffle first portion 112 is spaced apart from the housing 102 such that a second air vent 128 is defined. In some embodiments, the second baffle first portion 112 is oriented vertically (e.g., 90 degrees from horizontal). However, it is possible for the second baffle first portion 112 to have other angles relative to horizontal. For example, the second baffle first portion 112 can be angled approximately 45-89 degrees from horizontal. The second air vent 128 is configured to provide a conduit through which trapped air can travel to reach the fill line 130. In some embodiments, the first air vent 126 and the second air vent 128 are substantially the same size (e.g., the horizontal distance between the housing 102 and the first baffle first portion 108 is substantially similar to the horizontal distance between the housing 102 and the second baffle first portion 112). In some instances, the first air vent 126 and the second air vent 128 are different sizes. In an example implementation, the first air vent 126 and the second air vent 128 are at least 0.25 inches (e.g., the horizontal distance between the housing 102 and both the first baffle first portion 108 and the second baffle first portion 112 is at least 0.25 inches).

The second baffle second portion 114 is integrally formed with or otherwise coupled to the second baffle first portion 112 and extends from the bottom of the second baffle first portion 112 such that the second baffle second portion 114 is angled toward the bottom of the de-aeration tank 100. The second baffle first portion 112 and the second baffle second portion 114 are configured such that the angle between the second baffle first portion 112 and the second baffle second portion 114 is a nonzero angle. The second baffle second portion 114 is configured to direct fluid (e.g., coolant) toward the bottom of the de-aeration tank 100 by providing a surface on which fluid can flow.

In some embodiments, the second baffle second portion 114 does not extend to the bottom of the de-aeration tank 100. In such embodiments, the end of the second baffle second portion 114 is spaced apart from the bottom of the de-aeration tank 100 by a distance b. The end of the first baffle second portion 110 may not extend to contact the second baffle second portion 114. The end of the first baffle second portion 110 is spaced apart from the second baffle second portion 114 by a distance a. In some arrangements, the distances a and b are substantially the same (e.g., the value of the distance a and the value of the distance b are within 0.125 inches of each other). The distances a and b are large enough to provide for sufficient fluid flow, and are generally at least 0.75 inches. In some embodiments, the distances a and b are not substantially the same (e.g., the value of the distance a and the value of the distance b differ by more than 0.125 inches).

The first inlet vent 116 and the second inlet vent 118 are apertures through which fluid flows into the de-aeration tank 100. Specifically, the first inlet vent 116 and the second inlet vent 118 are part of a cooling circuit through which coolant flows, the first inlet vent 116 and the second inlet vent 118 directing coolant into the de-aeration tank 100 after the coolant has traveled through the cooling circuit. In some embodiments, the flow of coolant entering the de-aeration tank 100 is 3-10 gallons per minute (GPM). In some arrangements, the flow of coolant entering the de-aeration tank 100 is 5-7 GPM.

The pump inlet 120 is a conduit through which fluid (e.g., coolant) flows as it enters the cooling circuit. The pump inlet 120 leads to a coolant pump that is configured to pump the coolant through the cooling circuit. The pump inlet 120 defines an aperture 122 located in the housing 102, the aperture 122 providing a space through which coolant flows from the de-aeration tank 100 and into the pump inlet 120. The vortex breaker 124 is coupled to the housing 102 and is configured to prevent the coolant from creating a vortex as it flows through the aperture 122 and into the pump inlet 120. The vortex breaker 124 can be of any design suitable for its purpose. Example designs of the vortex breaker 124 include, but are not limited to, radial vanes, baffles, floor grates, posts, and any other design that results in prevention of a vortex as coolant flows through the aperture 122.

### III. Example Operation of the De-aeration Tank

In operation, coolant that has traveled through the cooling circuit of the engine of a vehicle returns to the de-aeration tank 100 via the first inlet vent 116 and the second inlet vent 118. In some embodiments, coolant returning to the de-aeration tank 100 may have air trapped within it. To increase cooling efficiency, the trapped air should be removed such that the coolant can effectively cool the engine structures.

As the coolant enters the de-aeration tank via the first inlet vent 116 and the second inlet vent 118, the coolant contacts the first baffle 104. In some embodiments, the coolant may contact the first baffle first portion 108 of the first baffle 104. The first baffle first portion 108 prevents the coolant from flowing into the first air vent 126 and directs the coolant toward the first baffle second portion 110. In some arrangements, the coolant does not contact the first baffle first portion 108 and instead contacts the first baffle second portion 110. In either case, the coolant is directed along the first baffle second portion 110 toward the second baffle 106.

As the coolant flows from the first baffle 104 to the second baffle 106, the coolant contacts the second baffle second portion 114 of the second baffle 106. In some embodiments where the flow of coolant is sufficiently fast, the coolant may flow toward the second baffle first portion 112. The second baffle first portion 112 prevents the coolant from entering the second air vent 128 and directs the coolant along the second baffle second portion 114 toward the bottom of the de-aeration tank 100.

When the coolant reaches the bottom of the de-aeration tank 100, the coolant flows through and/or around the vortex breaker 124 and the aperture 122 such that the coolant enters the pump inlet 120 to cycle through the cooling circuit again.

In some embodiments, as the coolant flows from the first inlet vent 116 and the second inlet vent 118 to the pump inlet 120, the coolant includes air that must be removed before the coolant enters the cooling circuit. The configuration of the first baffle 104 and the second baffle 106 promote de-aeration of the coolant.

Generally, trapped air within the coolant will rise because air has a lower density than the coolant. As the coolant flows toward the bottom of the de-aeration tank 100 and the air rises, the first baffle 104 and the second baffle 106 direct the air toward the fill line 130, where the air can escape the coolant. For example, as the coolant flows along the second baffle second portion 114, trapped air in the coolant will rise and contact the underside of the first baffle second portion 110. The angle of the first baffle second portion 110 directs the air contacting the underside of the first baffle second portion 110 toward the first air vent 126. When the air reaches the first air vent 126, the air travels vertically through the first air vent 126 until it reaches the fill line 130 and exits the coolant.

Coolant with trapped air may also be present underneath the second baffle second portion 114. In such embodiments, the trapped air will rise and contact the underside of the second baffle second portion 114. The angle of the second baffle second portion 114 directs the air contacting the underside of the second baffle second portion 114 toward the second air vent 128. When the air reaches the second air vent 128, the air travels vertically through the second air vent 128 until it reaches the fill line 130 and separates from the coolant.

### IV. Experimental Results

Various experiments have been conducted using the de-aeration tank 100 of FIG. 1. In an exemplary experiment, the de-aeration tank 100 of FIG. 1 was constructed such that, when coolant fills the housing 102 to the fill line 130, the volume of coolant in the tank is approximately 1 gallon (e.g., 100% capacity is 1 gallon of coolant). The experiment was run to determine the percentage of air at the pump inlet 120, where a low percentage of air at the pump inlet 120 indicates effective removal of air by the first baffle 104 and the second baffle 106. Coolant was allowed to flow through the first inlet vent 116 and the second inlet vent 118 at a rate of 5 GPM. The results of the experiment showed that the percentage of air at the pump inlet 120 was less than 0.5% when the de-aeration tank 100 was filled to approximately 70% of its capacity, and remained less than 0.5% when the de-aeration tank 100 was filled to approximately 100% of its capacity.

### V. Construction of Example Embodiments

While this specification contains many specific implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a subcombination or variation of a subcombination.

As utilized herein, the term “approximately,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The term “coupled” and the like, as used herein, mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another, with the two components, or with the two components and any additional intermediate components being attached to one another.

It is important to note that the construction and arrangement of the system shown in the various example implementations is illustrative only and not restrictive in character. All changes and modifications that come within the spirit and/or scope of the described implementations are desired to be protected. It should be understood that some features may not be necessary, and implementations lacking the various features may be contemplated as within the scope of the application, the scope being defined by the claims that follow. When the language a “portion” is used, the item can include a portion and/or the entire item unless specifically stated to the contrary.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

Although only a few embodiments have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter described herein. For example, elements shown as integrally formed may be constructed of multiple components or elements, the position of elements may be reversed or otherwise varied, and the nature or number of discrete elements or positions may be altered or varied. The order or sequence of any method processes may be varied or re-sequenced according to alternative embodiments. Other substitutions, modifications, changes, and omissions may also be made in the design, operating conditions and arrangement of the various exemplary embodiments without departing from the scope of the present invention.

What is claimed is:

1. A de-aeration tank for removing air from a fluid, the de-aeration tank comprising:
a housing defining an interior volume;
a first baffle coupled to the housing, the first baffle comprising a first baffle first portion coupled to a first baffle second portion, the first baffle first portion extending away from the first baffle second portion at a nonzero angle, the first baffle second portion positioned so as to come into contact with the fluid entering the housing through an inlet vent;
a first air vent defined by a first distance between the first baffle first portion and the housing;
a second baffle coupled to the housing, the second baffle comprising a second baffle first portion coupled to a second baffle second portion, the second baffle first portion extending away from the second baffle second portion at a nonzero angle, the second baffle second portion positioned so as to come into contact with the fluid directed by the first baffle second portion and direct the fluid toward a bottom of the interior volume; and
a second air vent defined by a second distance between the second baffle first portion and the housing.

2. The de-aeration tank of claim 1, further comprising:
a pump inlet coupled to a bottom of the housing, the pump inlet defining an aperture through which fluid flows; and
a vortex breaker coupled to the bottom of the housing, the vortex breaker configured to prevent the fluid from forming a vortex as the fluid flows into the pump inlet.

3. The de-aeration tank of claim 1, wherein the first baffle second portion is positioned so as to direct air contained in the fluid toward the first air vent, and the second baffle second portion is positioned to direct air contained in the fluid toward the second air vent.

4. The de-aeration tank of claim 3, wherein the first baffle first portion and the second baffle first portion extend above a fill line of the fluid within the housing.

5. The de-aeration tank of claim 4, wherein first air vent and the second air vent are positioned so as to direct the air contained in the fluid to the fill line.

6. The de-aeration tank of claim 1, wherein an end of the first baffle second portion is spaced apart from the second baffle second portion by a first distance to permit fluid flow between the first baffle second portion and the second baffle second portion.

7. The de-aeration tank of claim 6, wherein an underside of the first baffle second portion is positioned to direct air contained in the fluid toward the first air vent.

8. The de-aeration tank of claim 1, wherein an end of the second baffle second portion is spaced apart from a bottom of the de-aeration tank by a second distance to permit fluid flow between the second baffle second portion and the bottom of the de-aeration tank.

9. The de-aeration tank of claim 8, wherein an underside of the second baffle second portion is positioned to direct air contained in the fluid toward the second air vent.

10. A fluid circuit for circulating fluid through an engine system, comprising:
a de-aeration tank comprising:
a housing defining an interior volume;
a first baffle coupled to the housing, the first baffle comprising a first baffle first portion coupled to a first baffle second portion, the first baffle first portion extending away from the first baffle second portion at a nonzero angle;
a first air vent defined by a first distance between the first baffle first portion and the housing;
a second baffle coupled to the housing, the second baffle comprising a second baffle first portion coupled to a second baffle second portion, the second baffle first portion extending away from the second baffle second portion at a nonzero angle; and
a second air vent defined by a second distance between the second baffle first portion and the housing;
an inlet vent coupled to the housing and positioned above a fill line of the fluid, the inlet vent configured to direct fluid to the first baffle; and
a pump inlet coupled to the housing and positioned at a bottom of the housing, the pump inlet configured to direct fluid to a fluid pump.

11. The fluid circuit of claim 10, wherein the first baffle second portion is positioned so as to come into contact with the fluid entering the housing through an inlet vent, and the second baffle second portion is positioned so as to come into contact with the fluid directed by the first baffle second portion and direct the fluid toward a bottom of the interior volume.

12. The fluid circuit of claim 11, further comprising a vortex breaker coupled to the bottom of the housing, the vortex breaker configured to prevent the fluid from forming a vortex as the fluid flows into the pump inlet.

13. The fluid circuit of claim 11, wherein the first baffle second portion is positioned so as to direct air contained in the fluid toward the first air vent, and the second baffle second portion is positioned to direct air contained in the fluid toward the second air vent.

14. The fluid circuit of claim 13, wherein the first baffle first portion and the second baffle first portion extend above a fill line of the fluid within the housing.

15. The fluid circuit of claim 14, wherein first air vent and the second air vent are positioned so as to direct the air contained in the fluid to the fill line.

16. A baffle system for a de-aeration tank, comprising:
a first baffle configured to couple to a housing, the first baffle comprising a first baffle first portion coupled to a first baffle second portion, the first baffle first portion extending away from the first baffle second portion at a nonzero angle;
a second baffle configured to couple to the housing, the second baffle comprising a second baffle first portion positioned opposite the first baffle first portion, the second baffle first portion coupled to a second baffle second portion, the second baffle first portion extending away from the second baffle second portion at a nonzero angle;
wherein when the first baffle and the second baffle are coupled to the housing, an end of the first baffle second portion is positioned a first distance above the second baffle second portion.

17. The baffle system of claim 16, wherein when the first baffle and the second baffle are coupled to the housing, an end of the second baffle second portion is positioned a second distance above a bottom of the housing.

18. The baffle system of claim 17, wherein when the first baffle and the second baffle are coupled to the housing, a first air vent is defined by a first distance between the first baffle first portion and the housing, and a second air vent is defined by a second distance between the second baffle first portion and the housing.

19. The baffle system of claim 18, wherein the first baffle second portion is configured to direct fluid toward the second baffle second portion.

20. The baffle system of claim 19, wherein an underside of the first baffle second is positioned to direct air contained in the fluid toward the first air vent, and an underside of the second baffle second portion is positioned to direct air contained in the fluid toward the second air vent.
